(19) United States
(12) Patent Application Publication
(10) Pub. No.: US 2017/0310802 A1
(43) Pub. Date: Oct. 26, 2017

(54) EMERGENCY SERVICES ACCESS DEVICE

(71) Applicant: Polymer Braille Inc., Raleigh, NC (US)

(72) Inventor: Wallace Shepherd Pitts, Raleigh, NC (US)

(21) Appl. No.: 15/493,076

(22) Filed: Apr. 20, 2017

Related U.S. Application Data
(60) Provisional application No. 62/325,037, filed on Apr. 20, 2016.

(51) Int. Cl. H04M 1/247; H04M 1/725; H04W 4/22; H04M 11/06

(52) U.S. Cl. CPC H04M 1/2474; H04W 4/22; H04M 1/72591; H04M 1/72594; H04M 11/066

(57) ABSTRACT

Various examples are provided for emergency services access devices. In one embodiment, a telecommunication device includes one or more buttons that, when activated, cause the telecommunications device to communicate a corresponding emergency communication to one or more emergency services. The device can be configured to contact emergency services at the push of a button to indicate the type and location of the emergency. The severity of the emergency can also be indicated. The device can be used in a larger connected device topology that would enable more advanced functionality.

### CROSS REFERENCE TO RELATED APPLICATIONS

This application claims priority to, and the benefit of, co-pending U.S. provisional application entitled “Emergency Services Access Device” having Ser. No. 62/325,037, filed Apr. 20, 2016, which is hereby incorporated by reference in its entirety.

### BACKGROUND

Previously, many Braille display manufacturers provided a device called Telebraille. These devices allowed individuals to directly access 911 services through a Teletype/Telecommunications Device for the Deaf (TTY/TDD). These devices typically had a display so that the visually impaired user could converse with the remote operator at a Public Safety Answering Point (PSAP). New devices offer 911 services through a relay services which don't allow for direct access to emergency services.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of an emergency service access device, in accordance with various embodiments of the present disclosure.

FIG. 2 is a schematic representation illustrating an example of the hardware of the emergency services access device of FIG. 1, in accordance with various embodiments of the present disclosure.

FIGS. 3 and 4 are flow charts illustrating examples of the operation of the emergency services access device of FIG. 1, in accordance with various embodiments of the present disclosure.

FIGS. 5A and 5B illustrate an example of the implementation of the 9-1-1 emergency services access application on a mobile device, in accordance with various embodiments of the present disclosure.

FIG. 6 is a schematic diagram illustrating an example of an embedded system of the emergency services access device of FIG. 2 or the mobile device of FIG. 5A, in accordance with various embodiments of the present disclosure.

### DETAILED DESCRIPTION

Disclosed herein are various examples related to emergency services access devices. The existing technology no longer supports direct access to these services and thus may result in a delay in action from first responders. Furthermore, individuals with varying disabilities further exacerbates ease of access to emergency services. This device can act as a standalone 911 interface through the use of buttons that allow push button access to emergency services as well as the ability to tether to existing Braille, TTY/TDD, keyboards, etc. to provide telebraille like operations or an accessibility bridge and beyond. Reference will now be made in detail to the description of the embodiments as illustrated in the drawings, wherein like reference numbers indicate like parts throughout the several views.

Two basic approaches can be supported: Direct access to 9-1-1 and communication with a 9-1-1 Public Safety Answering Point (PSAP) call-taker in text or a combination of text and voice; and/or indirect access via any approved form of telecommunications relay service (TRS), where a communications assistant or interpreter is involved in the call and the PSAP call-taker experiences the call as a voice call. Public switched telephone network (PSTN) technologies that can be used by people with disabilities to call 9-1-1 include tele-typewriter (TTY) and/or internet based communications.

Direct Landline Calling.

Federal regulation requires that PSAPs provide direct access to individuals who use TDDs/TTYs. To comply, PSAPs equip call-taker stations with TTY capability. On silent calls (that may or may not be from a TTY user), the PSAP probes for TTY. People who can speak but who cannot hear can use “voice carry-over” to communicate with the PSAP; where they speak and the PSAP call-taker types back. Because TTY calls are infrequent relative to voice calls, call-takers sometimes erroneously hang up on TTY callers; however many PSAPs handle 9-1-1 TTY calls well.

Direct Wireless Calling.

Since 2002, wireless networks have been able to handle TTY calls through cellular telephones. However, the size of the TTY relative to the wireless device is quite large and consumers often find it too cumbersome for routine wireless use and particularly for emergency use. TTY functionality could be built into those handsets that have keyboards and screens, and then deaf callers could call 9-1-1 wirelessly.

Indirect Calling.

TTY users may choose to call through a traditional relay service. The relay service has responsibility for identifying the most appropriate PSAP for the caller's address, and calling that PSAP on a ten-digit number. The call, from the PSAP perspective, is a voice call, and possible mishandling on the PSAP end is avoided by using a TRS. The two-step calling process, however, introduces an unknown amount of delay.

Captioned Telephone.

A PSTN-based relay service allows the deaf or hard of hearing user to listen to the other party's speech while simultaneously viewing a transcription of the speech on a screen on the phone. The user speaks directly to the other party, and the CA is silent on the call. Users can call directly into 9-1-1; and the device can automatically turn itself into a voice-carry-over TTY. An alternate 2-line form allows the user to call to 9-1-1 and merge the relay service (on line 2) into the 9-1-1 call. Because these calls are a direct landline call from the user's location, it goes into the selective routing system.

IP-Relay.

Internet-Protocol Relay (IP text relay) can provide a text relay service using the internet instead of the PSTN. Two basic types of interfaces include websites and instant-messaging platforms. By visiting the website of an IP text relay provider, the user may place calls from any computer attached to the Internet. The wireless form of this service currently makes use of commercial instant messaging for the text leg of the call. A phone number is provided to the user, so that incoming calls are also supported. However, a limitation of web-based sites is that users cannot receive calls. The challenges presented by this method of relay service, in the 9-1-1 emergency context, are significant. For example, because of the portability of the wireless device, the CA (call assistant) obtains no location information without input from the user; therefore, the CA must first ascertain location information from the user and determine the contact information for the appropriate PSAP, before the call can be connected to the PSAP to report the emergency.

Video Relay Services.

Video Relay Service (VRS) uses Internet Protocol to send a video image so that the person who is deaf or hard of hearing can speak with a video interpreter using American Sign Language (ASL). The video interpreter uses voice to communicate with the hearing person on the other end of the call. The same issues associated with ascertaining the location of the 9-1-1 caller associated with IP-Relay are also associated with VRS, except that VRS is currently fairly stationary. Webcams and videophones are not available everywhere, and there is no cellular form of VRS at this time.

VoIP.

Voice-over-Internet Protocol (VoIP) telephony is a rapidly expanding technology and, for some people who are deaf or hard of hearing, has many of the same attractions as for the hearing consumer such as low cost and advanced features. On the other hand, many people who are deaf and who do not have hearing family members or roommates do not subscribe to VoIP as they do not have a need for it. Some VoIP services are incompatible with TTY, so even if they can route a call to 9-1-1, they would not be accessible given the current limitation to calling via TTY. VoIP's 9-1-1 routing problems have been addressed by the FCC in the 2005 FCC Report and Order. The problem of interfacing VoIP with TTY has not been resolved by the FCC.

Instant Messaging.

Instant messaging is a form of text communication in which short messages are sent among parties on the Internet. IM is popular with deaf and hard of hearing people as well as the hearing population. However, IM is not standardized and is not interoperable between competing companies. Although a standardized form of IM has been described in industry standards, it is not clear whether one interoperable form of IM will actually ever develop. PSAPs do not accept instant messages, and there is not yet any technical capability for a PSAP to determine the location of an incoming IM, or to determine whether the contact is from someone with a legitimate emergency.

SMS Text Messaging.

Short Message Service (SMS) is a form of messaging that operates in the wireless networks. Use of SMS text messaging, via cellular telephones or other mobile devices, is a potential alternative for a person who is deaf or hard of hearing to contact emergency services while on the road. However there are problems associated with the use of SMS for 9-1-1 calling. First, unlike standard “real time” voice calls, SMS operates as a “store and forward” service. Therefore, any number of variables can delay the delivery of an SMS message, anywhere from ten seconds to ten minutes or longer, and there is no guarantee of delivery. Furthermore, a 9-1-1 caller will not even know whether the message is received, unless the PSAP sends a return message. Moreover, if further details from the caller such as location or the nature of emergency are needed, SMS does not allow for the PSAP to obtain the information in “real time.” Finally, and most significantly, while SMS is used in some locations in other countries, PSAPs do not accept short messages in this country.

E-mail.

E-mail has many obvious benefits for people who are deaf or hard of hearing. Yet, it also has many of the same problems as with other messaging technologies, including ascertaining location information, dependence on a server, and delay as messages are sent back and forth.

Interactive Text/Total Conversation.

Currently there is no standardized form of text by which people can “call” or contact each other and be assured of a connection. The absence of such a form of communication in multi-media telecommunications has led to the fragmentation of text services as “features” rather than fundamental forms of communication over the Internet. Standards have been written for interactive text communication, but the industry has declined to implement these standard forms.

PSAPs, which now accept only telephone calls and TTY calls, are only beginning the process of transition needed to accommodate newer network technologies. Consumers with disabilities have a need for PSAPs to provide an Internet Protocol (“IP”) environment that is compatible with disabled-consumer advanced technologies. Examples of technological considerations to satisfy accessibility include:
Access to 9-1-1 through multiple communications technologies;
Automatic location identification (ALI) technologies that are functionally equivalent with those employed for voice calls (e.g., an automated system can alleviate some of the disadvantages of some non-voice communications such as, e.g., typing of responses is usually slower than voice communications;
Instantaneous routing of emergency communications by relay call center personnel to specific PSAPs through the 9-1-1 calling network (e.g., selective routers or methods by which the relay center can transparently pass through location and other data made available from the user's equipment to a non-9-1-1 number associated with the PSAP);
Support of automated and instantaneous “call backs” from the PSAP to the caller; and/or
Accommodation of direct text communications in all of a PSAP's operations: recording of conversations, queuing, etc.

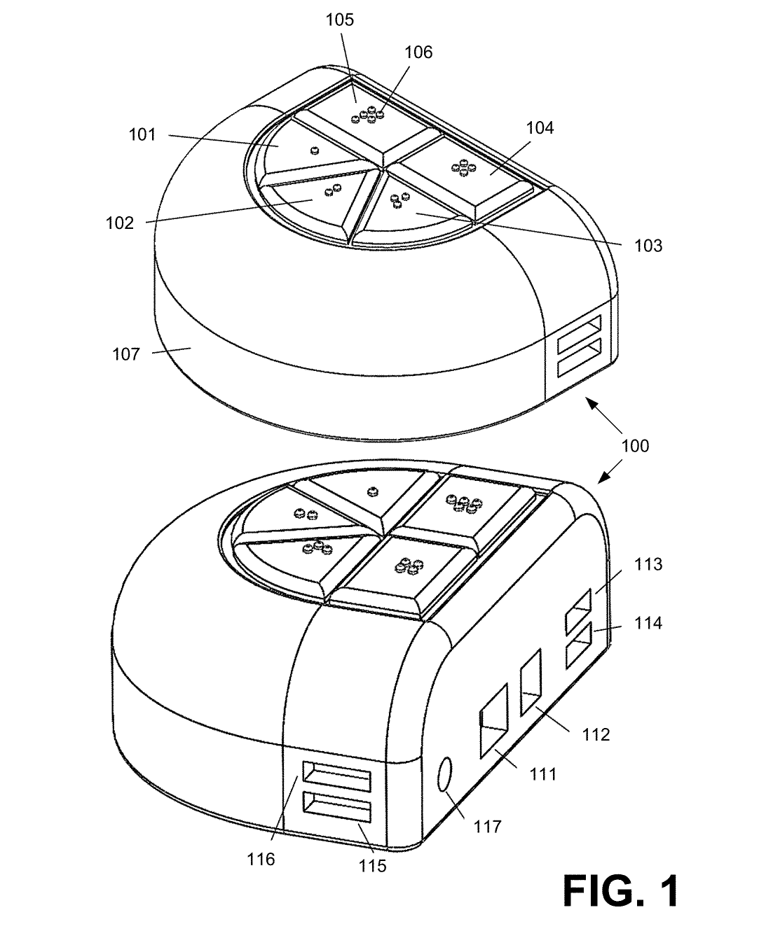

A device is presented that allows access to emergency services from all individuals. Referring to FIG. 1, shown is an example of an emergency services access device 100 that not only allows for existing technologies such as Braille displays, video monitors, keyboards, etc. to be used to access these services (enabling bidirectional or even unidirectional communication); but also allows push button access that can relay immediate information to the emergency personnel. As illustrated in FIG. 1, the emergency services access device 100 can include one or more buttons 101, 102, 103, 104, and/or 105 to allow a user to initiate actions by the device. For example, the buttons can be preprogrammed to initiate a specific emergency call or response such as, but not limited to calling 9-1-1 for a fire emergency 101, calling 9-1-1 for a medical emergency 102, calling 9-1-1 for a police emergency 103, calling and/or texting an emergency message to a defined list of people 104 and/or calling 9-1-1 for a general emergency 105. In some implementations, the device 100 can be configured to allow the buttons 101-105 to be reprogrammed for different functions as desired by the user. The defined list of people for button 104 can also be also be specified through a user interface (UI).

The interactive nature (shapes, colors, tactile, illumination, sound, etc.) of the buttons 101-105 can be varied to ensure that the user can easily identify the individual button. An example of varying the tactile nature and shapes of buttons 101-105 is shown in FIG. 1, where the buttons 101-105 can include a Braille pattern 106 including one or more letter, number and/or word that would indicate the function of that button (e.g., 105). The emergency services access device 100 can be provided in a compact enclosure 107 to facilitate use by an individual and protect the hardware inside the case.

The messaging system can be used to convert text to audio and audio to text to facilitate communications between deaf and/or dumb individuals in place or in augmentation of text messages. This could improve the communication modalities between the parties on the line. For example, a 911 operator without a TTY terminal could be prompted to press a numeric key to initiate a text to voice and voice to text dialog. The conversation could then be carried out with a connected TTY terminal in much the same manner as a TTY to TTY call.

The emergency services access device 100 can be configured to connect to other devices, networks and/or systems through wired and/or wireless connections. For example, the device 100 can be communicatively coupled through links or connections such as, but not limited to, Bluetooth®, Bluetooth® Low Energy, WFi, Cellular, optical, USB, modem, Ethernet, etc. The emergency services access device 100 can include one or more wireless interfaces to establish one or more communication links with other devices, networks and/or systems. As illustrated in FIG. 1, various hardwire connections (or connection ports) 111-116 can be used to communicatively couple to the emergency services or to existing devices or systems that the user might have to aid in communication with emergency services. A power connection 117 can be provided for connection to an external power source for the emergency services access device, or one or more of the other hardwire connections 111-116 can provide power (e.g., through a USB port). In some embodiments, the emergency services access device can include batteries or other backup power source to allow operation without access to the external power source.

For example, connection ports 111 and 112 can be configured to accept hardwire connections to Ethernet and PSTN, respectively. Other connection ports (e.g., USB, HDMI, optical, etc.) 113, 114, 115 and/or 116 can be configured for connections with visual, audio, haptic or other type of display device to facilitate interaction with user of the device. Furthermore, the device can also be configured to connect with one or more base stations (e.g., a modern day cordless phone) that can be placed in multiple rooms yet still communicate with the other base stations. The connection can be made through one or more of the connections 113-116. In addition, the device 100 may also be connected to surrounding devices and/or infrastructures such as, but not limited to, a house alarm, sirens, strobe lights, fire alarms, etc. so that it may alert others in the proximity of an emergency situation.

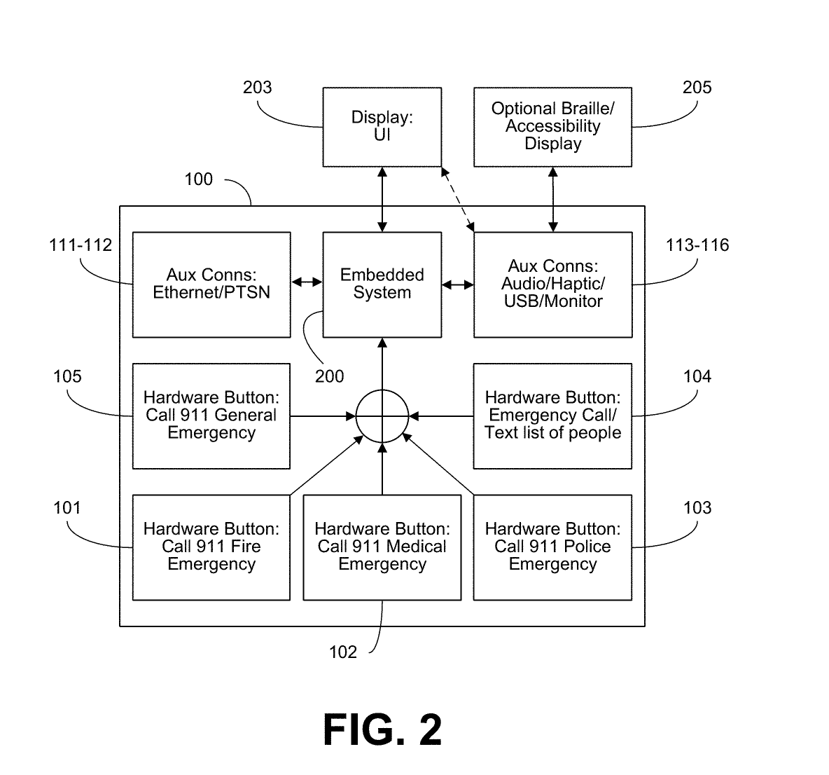

Referring next to FIG. 2, shown is a schematic representation of the hardware of the emergency services access device 100. As previously discussed, the device 100 includes buttons 101-105 that are configured to initiate a specific emergency call or response. The buttons 101-105 are communicatively coupled with an embedded system so that activation of the button 101-105 (e.g., by pressing) provides an indication to the embedded system 200. The embedded system 200 can include processing circuitry comprising a processor and memory (e.g., an android based system) that can be configured to execute the features of the emergency services access device 100. The embedded system 200 can also include modem and/or global positioning system (GPS) modules to facilitate TTY/TTD communications and identification of the location of the device 100, and thus the user. The embedded system 200 can be similar to the systems used in mobile communication devices such as, e.g., smartphones and tablets. A display 203 can also be included to provide a user interface (UI) with the embedded system 200. The display can be integrated with the emergency services access device 100, or can be a separate device that is communicatively coupled to the embedded system 200 through a wireless link or through a hardwire connection via one of the connections 113-116. A Braille display 205 can also be attached to the device 100 through one of the connections 113-116 to allow for tactile outputs for deaf and dumb individuals or other operations. Other features such as, e.g., microphones and speakers can also be included in the emergency services access device 100.

Interaction with the emergency services access device 100 can be through a standalone device such as, e.g., a smartphone, tablet or other mobile computing device or can be through a cloud based platform that allows remote management of the device 100 or interaction with the individuals. For example, an advanced system might have a portal to log into through some communication means that would allow the user or remote party to setup, configure and/or add additional information to the messages or even to message other third parties through methods such as, but not limited to, email, text messaging, phone call, video, etc. A third party may be brought in as part of a three way call (or IP Relay). This way, 911 can be directly established and VRS or third party can be brought in with a secondary. Presently, it is call VRS wait, connect to 911 wait, then conversation. By reversing the order, 911 is contacted first and can be additionally augmented by a third party service or person. In addition, font sizes can be user adjustable to aid visually impaired (but not blind) users. In some implementations, the device can include or can be configured to couple with an image capture device (e.g., through connections 113-116) to facilitate video communications.

Once a user presses one of the buttons 101-105, a corresponding signal is sent to emergency services using existing communications methods. In response to activation of a button, a pre-recorded message (audio, text, video, etc.) can be sent to the emergency services. The message can give 911 services bio/medical information about the user and what type of emergency it is. Hardware buttons 101-105 should always be listening, so if the embedded system 200 loses focus the buttons 101-105 will bring it back to focus. For example, pressing button 101 can indicate that emergency services are needed from the fire department, pressing button 102 can indicate a medical emergency, pressing button 103 can indicate the need for police services, etc. Additionally, there might be an additional button 105 that would indicate a general emergency situation. The embedded system 200 can also acquire the GPS location and include the information in the message (e.g., when no address is available for the device location). Further details that may prove important for first responders to know can also be added to the message such as, but not limited to, medications, pre-existing conditions, disability of the individual, etc. When acknowledgement of the 9-1-1 message is received by the device 100, an indication (e.g., a tactile vibration) can be provided to the user.

In some implementations, the emergency services access device 100 includes a pre-recorded preamble message that can be sent when a call is first established with 9-1-1. The preamble message can prompt the 9-1-1 service for a response before sending additional information about the user and/or location. For instance, the preamble message can be “THIS IS A TTY/TDD XXX EMERGENCY CALL. PRESS ANY KEY TO GET MORE INFORMATION . . . ,” where the “XXX” term is replaced by the type of emergency call (e.g., “FIRE,” “MEDICAL,” “POLICE,” or “GENERAL”) corresponding to the activated hardware button. Once the 9-1-1 system responds to the preamble message, a list of options can be provided to the 911 operator like an old text menu interface in the command line terminal. Examples of options for available to the 9-1-1 operator includes, but is not limited to, the following:
Provide location information: Address and GPS of individual;
Provide medical information about the individual (e.g., disability type, mobility and/or other pertinent information),
Provide household information such as, e.g., number, names, and/or ages of people in the house;
Provide a list of emergency contacts;
Initiate live chat through device 100, which can include an indication of availability of e.g., keyboard to keyboard communications;
Listen in through device 100, which can include a microphone and/or speakers; and/or
Vibrate device 100 to acknowledge emergency and that help is on the way.
   The status of the call should be displayed through the emergency services access device 100 showing the information displayed. The device 100 can be configured to allow the user (or emergency caller) to send a message at any time to the 9-1-1 operator by typing the message in their messaging window and pressing send. The live chat window can be similar to an instant messaging window, except that information originating from the 9-1-1-center would be streamed and seen live as the 9-1-1 operator types.

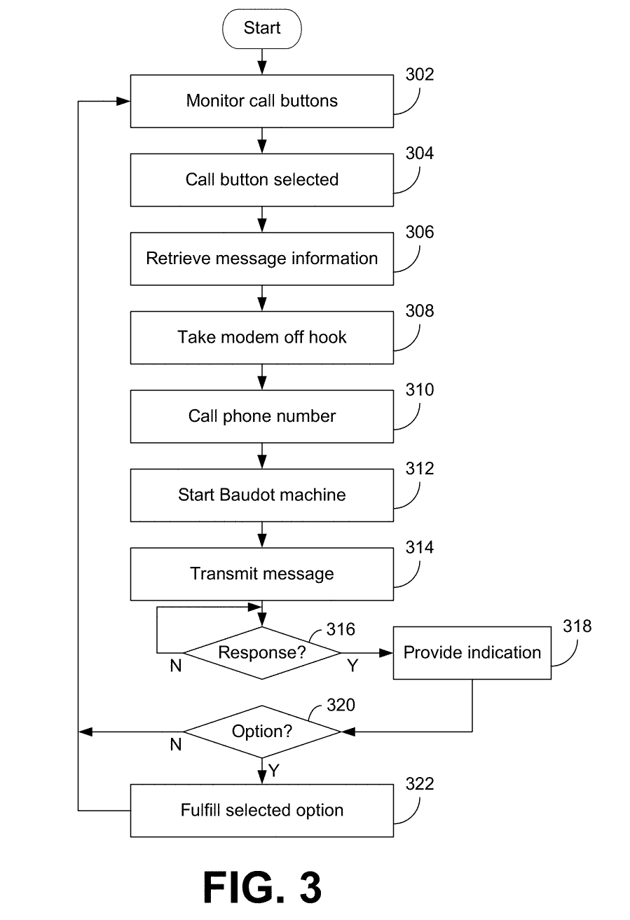

Referring next to FIG. 3, shown is a flow chart illustrating an example of initiation of an emergency services call in response to one of the buttons 101-105. Beginning at 302, the embedded system 200 monitors the call buttons 101-105. This means that the application can be a service that runs in the background with a GUI as a front end. When a call button 101-105 is selected at 304, message information based upon the button selection is retrieved at 306 and the UI can be updated with the status of the selection. The message information includes one or more emergency services telephone number(s) and/or one or more individual(s) to be contacted in response to selection (or activation) of the button 101-105. Depending on the configuration of the pre-recorded message, the message information can also include location information (e.g., GPS location) and/or user information for inclusion in the pre-recorded message.

At 308, the modem of the embedded system 200 is taken off hook and the call to the emergency services center is initiated at 310 using the telephone number. The UI can also be updated to indicate the modem status. A Baudot machine (or other machine-to-machine communication protocol) is started at 312 to facilitate TTY/TTD communication with the emergency services center. After the call has been established, the pre-recorded message including the appropriate information can then be transmitted at 314 and the UI can also be updated. As previously discussed, the pre-recorded message can be a preamble message that allows the emergency services operator to select an subsequent action by the device 100, or the pre-recorded message can be a single transmission including the retrieved information.

The emergency services access device 100 can then wait for a response from the emergency services center at 316. The application can continue waiting for a response for a defined period of time. If no response is received, the device 100 can continue monitoring for the response or, in some implementations, a second message can be transmitted after a predefined time limit has been exceeded. When a response is received at 316 from the emergency service center indicating that the message was received, an acknowledgement indication can be provided to the user at 318 by the emergency services access device 100. For example, a tactile indication such as vibration of the device 100 can be provided. If the message provided options to the emergency services center, then operator's response is evaluated at 320 and the selected option is fulfilled at 322. The UI can also be updated to indicate the current status. Once the message options have been fulfilled, then the flow can return to monitoring the call buttons at 302.

Alternatively, another form of connection to the phone line can be established similar to that of a headset that telephone operators use. The device can emulate what a user would do by electrically controlling taking the phone off hook and put the phone back on hook and use the audio connections to transmit and receive the desired information.

The emergency services access device 100 can also be used to communicate with other TTY/TTD compatible services or devices. These communications can be facilitated through a Braille or other accessibility display or interface 205 connected to the device 100. At 402, a call request is received by the embedded system 200 from a user of the device 100. Message information can be obtained at 404 to establish the call. For example, the telephone number of the service or device can be provided by the user or can be obtained from information stored in memory. At 406, the modem of the embedded system 200 is taken off hook and the call is initiated at 408 using the telephone number. The UI can also be updated to indicate the modem status. The Baudot machine (or other machine-to-machine communication protocol) is started at 410 to facilitate TTY/TTD communications with the service or device. After the call has been established, the UI can be updated.

After the call has been established, a message can then be transmitted at 412. The message may have been obtained at 404, or the user can be prompted through the Braille or other accessibility interface 205 for a message. The device 100 can then wait for a response at 414. If a response is received, then the message can be provided to the user at 416 through the Braille or other accessibility interface 205. The user can choose to respond at 418 and the message can be transmitted at 420 before returning to 414. If the user decides not to respond at 418, then the call comes to an end and the modem is put back on hook. If no response is received at 414, then the user can choose at 422 to end the call or continue waiting for a response. A prompt may be provided if no response is received within a predefined time limit.

Emergency services access can also be implemented through a mobile device such as a smartphone or tablet. The application can allow the user to call 9-1-1 emergency services and establish a virtual TTY connection with the 9-1-1 operator. This facilitates a direct two way communication between emergency service personnel and an end user. The application can control the microphone and speaker of the cellular phone to allow the application to encode and decode text as Baudot or other communication protocol through the cellular connection.

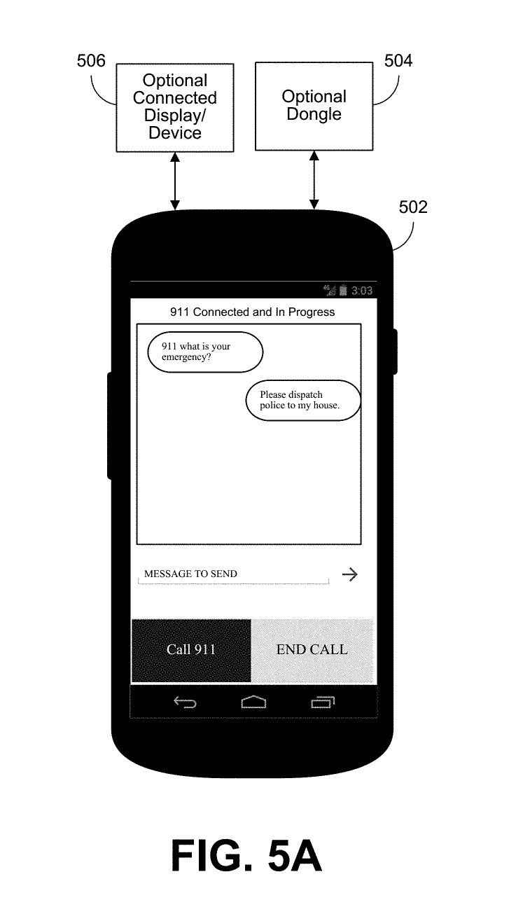

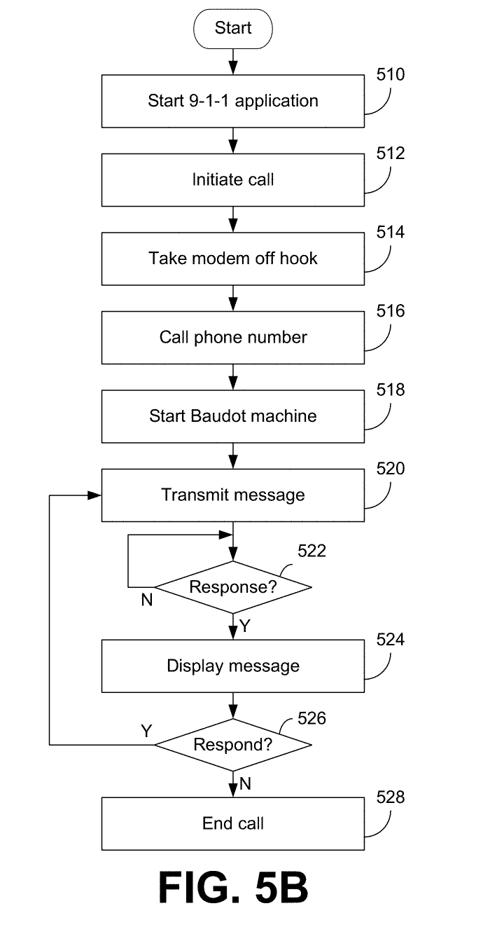

Referring to FIG. 5A, shown in an example of an emergency services access setup using a smartphone 502. A microphone/speaker connection 504 is provided to facilitate the TTY communications. The microphone/speaker connection 504 can be a physical connection (such as a dongle connected to the headphones port of the mobile device 502), a program or application (such as a HAL or mixer), or by proximity to the internal speaker/microphone. This link may be further supported by the ITU V.18 standard or other modem style communication. The application can implement a modem link that allows fast and effective communication with the 9-1-1 provider that mimics a live chat, instant message or text message. The application can also perform all the same functionality as the emergency services access device 100. This functionality can be provided through the voice channel or data channel of the cellphone application, but is not provided through the SMS or MMS functionality. This makes the application compatible with legacy 9-1-1 systems and the end user can directly communicate with emergency personnel without going through a relay service. Additionally, the application can be connected to a Braille display or to other standalone hardware 506 through a wireless or wired connection with the mobile device 502.

FIG. 5B is a flow chart illustrating an example of the 9-1-1 emergency services access application implemented on a mobile device such as the smartphone 502 of FIG. 5A. Beginning at 510, the 9-1-1 application is started on the mobile device. The user can initiate an emergency services call at 512 by, e.g., selecting the “Call 911” button as illustrated in FIG. 5A. The UI on the mobile device can be updated to indicate the call status.

At 514, the modem of the mobile device is taken off hook and the call to the emergency services center is initiated at 516 using the telephone number. A Baudot machine (or other machine-to-machine communication protocol) is started at 518 to facilitate TTY communication with the emergency services center. After the call has been established, a pre-recorded message can be transmitted at 520. The pre-recorded message can indicate to the emergency services operator that the call is a TTY communication. The UI on the mobile device can be updated to indicate the call status.

The application can then wait for a response from the emergency services center at 522. When a response is received at 522 from the emergency service center, the message can be displayed, e.g., through the UI. In some implementations, a tactile indication such as vibration can be provided through the Braille display or to other standalone hardware 506. The user can choose to respond at 526 and the message can be transmitted at 520, where the flow is repeated. If the user decides not to respond at 526, then the user can end the call by, e.g., selecting the “End Call” button as illustrated in FIG. 5A.

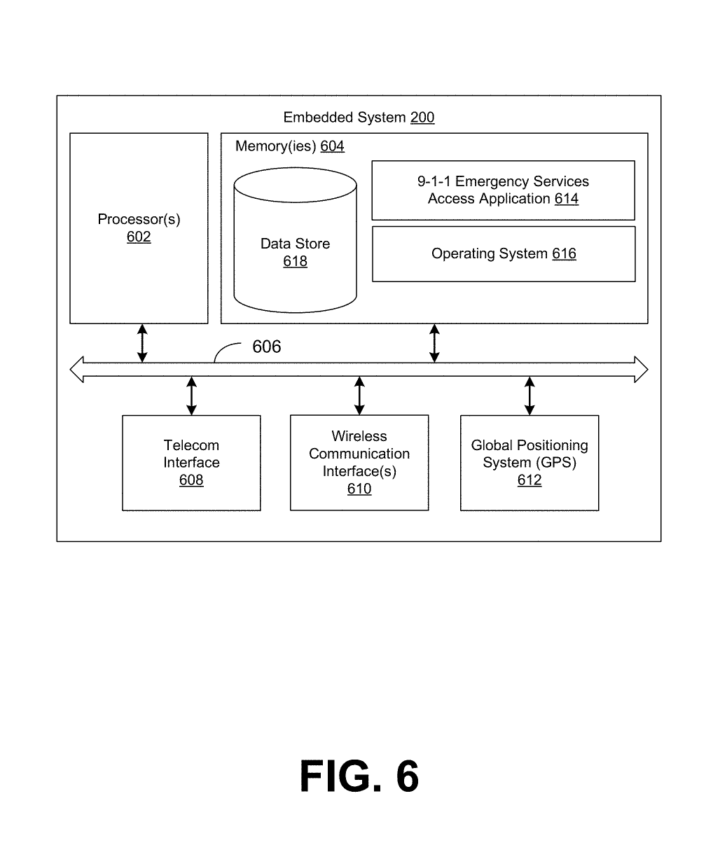

With reference to FIG. 6, shown is a schematic block diagram of an example of an embedded system 200 such as that found in the emergency services access device 100 of FIG. 2 or the mobile device 502 (e.g., a smartphone, tablet, etc.) of FIG. 5A. The embedded system 200 includes at least one processor circuit or processing circuitry, for example, having a processor 602 and a memory 604, both of which are coupled to a local interface 606. The local interface 606 may comprise, for example, a data bus with an accompanying address/control bus or other bus structure as can be appreciated. The embedded system 200 can also include a telecom interface (e.g., a modem) 608 and one or more other wireless communication interfaces (e.g., Bluetooth®, Bluetooth® Low Energy, WiFi or other appropriate wireless protocol) 610. The communication interface(s) 610 may comprise, for example, a wireless transmitter, a wireless transceiver, and/or a wireless receiver. The embedded system 200 can also include a global positioning system (GPS) 612.

Stored in the memory 604 can be a combination of data and/or several components that are executable by the processor 602. In particular, stored in the memory 604 and executable by the processor 602 can be a 9-1-1 emergency service access application 614, operating system 616, and potentially other applications. Also stored in the memory 602 may be a data store 618 and other data. It is understood that there may be other applications that are stored in the memory 604 and are executable by the processor 602 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

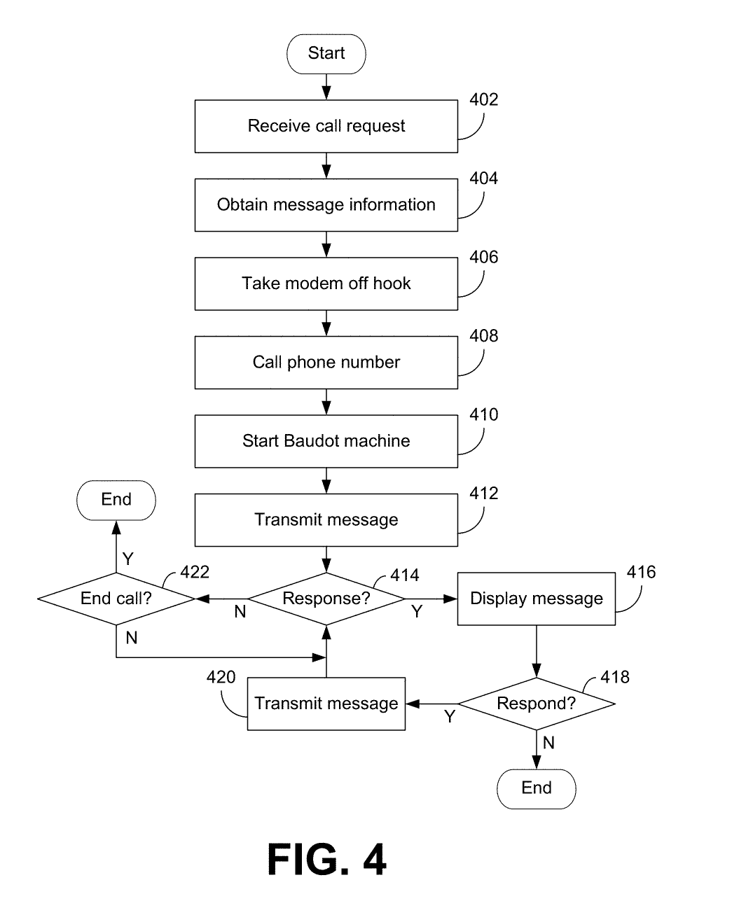

Although the flow charts of FIGS. 3, 4 and 5B show a specific order of execution, it is understood that the order of execution may differ from that which is depicted. For example, the order of execution of two or more blocks may be scrambled relative to the order shown. Also, two or more blocks shown in succession in FIGS. 3, 4 and 5B may be executed concurrently or with partial concurrence. Further, in some embodiments, one or more of the blocks shown in FIGS. 3, 4 and 5B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

A number of software components are stored in the memory 604 and are executable by the processor 602. In this respect, the term “executable” means a program file that is in a form that can ultimately be run by the processor 602. Examples of executable programs may be, for example, a compiled program that can be translated into machine code in a format that can be loaded into a random access portion of the memory 604 and run by the processor 602, source code that may be expressed in proper format such as object code that is capable of being loaded into a random access portion of the memory 604 and executed by the processor 602, or source code that may be interpreted by another executable program to generate instructions in a random access portion of the memory 604 to be executed by the processor 602, etc. An executable program may be stored in any portion or component of the memory 604 including, for example, random access memory (RAM), read-only memory (ROM), hard drive, solid-state drive, USB flash drive, memory card, optical disc such as compact disc (CD) or digital versatile disc (DVD), floppy disk, magnetic tape, holographic storage, or other memory components.

The memory 604 is defined herein as including both volatile and nonvolatile memory and data storage components. Volatile components are those that do not retain data values upon loss of power. Nonvolatile components are those that retain data upon a loss of power. Thus, the memory 1206 604 comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 602 may represent multiple processors 602 and/or multiple processor cores, and the memory 604 may represent multiple memories 604 that operate in parallel processing circuits, respectively. In such a case, the local interface 606 may be an appropriate network that facilitates communication between any two of the multiple processors 602, between any processor 602 and any of the memories 604, or between any two of the memories 604, etc. The processor 604 may be of electrical or of some other available construction.

Although the 9-1-1 emergency service access application 614, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the 9-1-1 emergency service access application 614, that comprises software or code can be embodied in any non-transitory computer-readable medium for use by or in connection with an instruction execution system such as, for example, a processor 602 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including 9-1-1 emergency service access application 614, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same embedded system 200. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A telecommunications device comprising:
one or more buttons that, when activated, cause the telecommunications device to communicate a corresponding emergency communication to one or more emergency services.

2. The device of claim 1, where the one or more buttons are uniquely identifiable through shape, texture, haptics, sound, or illumination.

3. The device of claim 1, wherein the telecommunications device is configured to directly communicate with emergency services.

4. The device of claim 1, where the telecommunications device communicates via a TTY or PSAP interface or to at least one other third party.

5. The device of claim 1, where the telecommunications device communicates via a TTY or PSAP interface and at least one other party concurrently.

6. The device of claim 5, where the telecommunications device concurrently communicates to another party that is a relay service.

7. The device of claim 1, further comprising an interface with a Braille device forming a TDD Device.

8. The device of claim 7, wherein the telecommunications device is configured for wired or wireless communications.

9. The device of claim 8, where the wired communication is via a USB connection or the wireless communication is via Bluetooth, Bluetooth Low Energy, or WiFi.

10. The device of claim 1, wherein the telecommunications device is configured to disseminate a pre-recorded audio/video/text message to the one or more emergency services as to the nature of the emergency.

11. The device of claim 1, further comprising a wireless interface.

12. The device of claim 11, wherein the wireless interface is a cellular modem.

13. The device of claim 1, further comprising an interface with a mobile or TTY device.

14. The device of claim 13, where the interface is configured for wireless communications via Bluetooth, Bluetooth Low Energy, or WiFi, or is configured for wired communication using a USB connection.

15. The device of claim 1, where the telecommunications device is configured to interface with additional emergency indicating devices.

16. The device of claim 15, where the additional emergency indicating devices comprise smoke alarms, security alarms, audible alarms, or visual alarms.

17. The device of claim 1, where the telecommunications device is configured for video to help identify the nature of the emergency.

18. The device of where the telecommunications device is configured to convert audio to text and/or text to audio to form the corresponding emergency communication.

19. The device of claim 1, where haptics are used as user feedback to indicate status, communication, or indicate buttons.

20. The device of claim 1, where the telecommunications device comprises a touch interface that allows a user to draw, sign, or spell to communicate the one or more emergency services.

21. The device of claim 1, where the telecommunications device is configured to use tactile forms of communication to interface or converse over the telecommunications device.

22. The device of claim 21, where the tactile forms of communication are provided via a touch interface.

23. The device of claim 21, where the tactile forms of communication are provided via an electrical apparatus or interface configured to invoke a physical response capable of discerning the transcribed information.

24. The device of claim 1, where gestures are used to indicate, communicate, or converse about the emergency via the device.
